(19) United States
(12) Patent Application Publication
(10) Pub. No.: US 2025/0071176 A1
(43) Pub. Date: Feb. 27, 2025

(54) TRAFFIC HANDLING METHOD FOR QUIC APPLICATION

(71) Applicant: ZTE CORPORATION, Shenzhen, Guangdong (CN)

(72) Inventors: Zhijun LI, Shenzhen (CN); Xingyue ZHOU, Shenzhen (CN); Jinguo ZHU, Shenzhen (CN)

(21) Appl. No.: 18/725,050

(22) PCT Filed: Feb. 7, 2022
(86) PCT No.: PCT/CN2022/075327

§ 371 Date: Jun. 27, 2024

(51) Int. Cl. H04L 67/141; H04L 47/20

(52) U.S. Cl. CPC H04L 67/141; H04L 47/20

(57) ABSTRACT

A wireless communication method for use in a first wireless network node is disclosed. The method includes receiving, by a session management node from a user plane node, a quick UDP Internet connection, QUIC, traffic handling support indication; and transmitting, by the session management node to the user plane node, a QUIC handling instruction in response to the QUIC traffic handling support indication to request the user plane node to detect a QUIC traffic.

### CROSS-REFERENCE TO RELATED APPLICATION(S)

The present application is a national phase entry under 35 U.S.C 371 of International Application No. PCT/CN2022/075327, filed on Feb. 7, 2022, the entire contents of the International Patent Application are incorporated herein by reference.

### TECHNICAL FIELD

This document is directed generally to wireless communications, and in particular to 5th generation (5G) communications.

### BACKGROUND

QUIC (Quick UDP Internet Connection) protocol is rapidly developing to setup Internet connection between two end points. It is regarded as the next generation protocol used for HTTP (Hyper Text Transfer Protocol), i.e. to be used to replace existing TCP (Transmission Control Protocol)+TLS (Transport Layer Security)+HTTP protocol.

A QUIC connection is a secured connection between two endpoints, e.g. between a UE and its Application Server, which disables a transmission node in the network to inspect the content transmitted in a QUIC connection.

Currently, the 5G packet detection and forwarding model illustrated in CUPS architecture can only detect a QUIC traffic from other TCP/UDP (User Datagram Protocol) traffic. Thus, it is difficult for the network to recognize which service the QUIC traffic is related to, and not possible to make the corresponding traffic handling policy.

### SUMMARY

This document relates to methods, systems, and devices for QUIC traffic.

One aspect of the present disclosure relates to a wireless communication method. In an embodiment, the wireless communication method includes: receiving, by a session management node from a user plane node, a quick UDP Internet connection, QUIC, traffic handling support indication; and transmitting, by the session management node to the user plane node, a QUIC handling instruction in response to the QUIC traffic handling support indication to request the user plane node to detect a QUIC traffic.

Another aspect of the present disclosure relates to a wireless communication method. In an embodiment, the wireless communication method includes: receiving, by a user plane node from a session management node, a quick UDP Internet connection, QUIC, handling instruction; and transmitting, by the user plane node to the session management node, a QUIC traffic report in response to the QUIC handling instruction.

Another aspect of the present disclosure relates to a wireless communication method. In an embodiment, the wireless communication method includes: transmitting, by a session management node to a policy control node, quick UDP Internet connection, QUIC, traffic parameters for a QUIC application; and receiving, by the session management node from the policy control node, Policy and Charging Control, PCC, rules for a QUIC application, wherein the PCC rules are used to generate Packet Forward Control Protocol, PFCP, rules to control a user plane node to perform a QUIC traffic detection.

Another aspect of the present disclosure relates to a wireless communication method. In an embodiment, the wireless communication method includes: receiving, by a policy control node from a session management node, quick UDP Internet connection, QUIC, traffic parameters for a QUIC application; and transmitting, by the policy control node to the session management node, PCC rules for the QUIC application, wherein the PCC rules are used by the session management node to control a user plane node to perform a QUIC traffic detection (e.g., the session management node may generate PFCP rules to control the user plane node to perform the QUIC traffic detection).

Another aspect of the present disclosure relates to a wireless communication method. In an embodiment, the wireless communication method includes: transmitting, by an application node to a policy control node, application service information for a quick UDP Internet connection, QUIC, application, to allow the policy control node to determine Policy and Charging Control, PCC, rules for a QUIC traffic detection.

Another aspect of the present disclosure relates to a wireless communication node. In an embodiment, the wireless communication node includes a communication unit and a processor. The processor is configured to: make the communication unit to receive from a user plane node, a quick UDP Internet connection, QUIC, traffic handling support indication; and make the communication unit to transmit to the user plane node, a QUIC handling instruction in response to the QUIC traffic handling support indication to request the user plane node to detect a QUIC traffic.

Another aspect of the present disclosure relates to a wireless communication node. In an embodiment, the wireless communication node includes a communication unit and a processor. The processor is configured to: make the communication unit to receive from a session management node, a quick UDP Internet connection, QUIC, handling instruction; and make the communication unit to transmit to the session management node, a QUIC traffic report in response to the QUIC handling instruction.

Another aspect of the present disclosure relates to a wireless communication node. In an embodiment, the wireless communication node includes a communication unit and a processor. The processor is configured to: make the communication unit to transmit to a policy control node, quick UDP Internet connection, QUIC, traffic parameters for a QUIC application; and make the communication unit to receive from the policy control node, Policy and Charging Control, PCC, rules for a QUIC application, wherein the PCC rules are used to generate Packet Forward Control Protocol, PFCP, rules to control a user plane node to perform a QUIC traffic detection.

Another aspect of the present disclosure relates to a wireless communication node. In an embodiment, the wireless communication node includes a communication unit and a processor. The processor is configured to: make the communication unit to receive from a session management node, quick UDP Internet connection, QUIC, traffic parameters for a QUIC application; and make the communication unit to transmit to the session management node, PCC rules for the QUIC application, wherein the PCC rules are used by the session management node to control a user plane node to perform a QUIC traffic detection.

Another aspect of the present disclosure relates to a wireless communication node. In an embodiment, the wireless communication node includes a communication unit and a processor. The processor is configured to: make the communication unit to transmit to a policy control node, application service information for a quick UDP Internet connection, QUIC, application, to allow the policy control node to determine Policy and Charging Control, PCC, rules for a QUIC traffic detection.

Various embodiments may preferably implement the following features:

Preferably, the QUIC handling instruction comprises at least one of a QUIC traffic detection indication, or a QUIC traffic reporting indication, wherein the QUIC traffic detection indication indicates to the user plane node that a QUIC traffic detection is required, and wherein the QUIC traffic reporting indication instructs the user plane node to report a detection of a QUIC traffic.

Preferably, the QUIC traffic handling support indication is received through a Packet Forwarding Control Protocol, PFCP, association setup request.

Preferably, the QUIC handling instruction is transmitted through a PFCP session establishment request.

Preferably, the method includes: receiving, by the session management node from the user plane node, a QUIC detection report comprising QUIC traffic parameters comprising at least one of: a transport protocol type setting to QUIC, an Internet Protocol, IP, address and a port number of a user equipment for a QUIC connection, a QUIC connection identification used by the user equipment, an IP address and a port number of a remote server for the QUIC connection, or a QUIC connection identification used by the remote server.

Preferably, the method includes: transmitting, by the session management node to the user plane node, a request to update Packet Forward Control Protocol, PFCP, rules according to the QUIC traffic parameters.

Preferably, the QUIC traffic report is transmitted through setting a report type of the QUIC traffic report as QUIC traffic detection, and setting the QUIC traffic report to comprise QUIC traffic parameters.

Preferably, the QUIC traffic report comprises QUIC traffic parameters comprising at least one of: a transport protocol type setting to QUIC, an Internet Protocol, IP, address and a port number of a user equipment for a QUIC connection, a QUIC connection identification used by the user equipment, a IP address and a port number of a remote server for the QUIC connection, or a QUIC connection identification used by the remote server.

Preferably, the method includes: receiving, by the user plane node to the session management node, a request to update Packet Forward Control Protocol, PFCP, rules according to the QUIC traffic parameters.

Preferably, the method includes: transmitting, by the user plane node to the session management node, a QUIC traffic handling support indication to notify the session management node that the QUIC handling instruction can be transmitted.

Preferably, the QUIC traffic parameters are transmitted through a session management policy association update request message.

Preferably, the QUIC traffic parameters comprises at least one of: a transport protocol type setting to QUIC, an Internet Protocol, IP, address and a port number of a user equipment for a QUIC connection, a QUIC connection identification used by the user equipment, a IP address and a port number of a remote server for the QUIC connection, or a QUIC connection identification used by the remote server.

Preferably, the PCC rules are transmitted through a session management policy association update response message.

Preferably, the PCC rules comprise at least one of: application information, a flow description for identifying an QUIC connection, or Quality of Service, QoS, parameters associated to the QUIC connection.

Preferably, the application information comprises at least one of: an application identification or an application service type.

Preferably, the flow description comprises at least one of: an Internet Protocol, IP, address and a port number of a user equipment for a QUIC connection, a QUIC connection identification used by the user equipment, a IP address and a port number of a remote server for the QUIC connection, or a QUIC connection identification used by the remote server.

Preferably, the QoS parameters comprises at least one of: a QoS Flow Identifier, QFI, an Allocation and Retention Priority, ARP, a maximum bandwidth of uplink transmission, a maximum bandwidth of a downlink transmission, a guaranteed bandwidth of an uplink transmission, or a guaranteed bandwidth of a downlink transmission.

Preferably, the method includes: transmitting, by the session management node to the user plane node, the PFCP rules comprising at least one of a Packet Detection Rule, PDR, a QoS Enforcement Rule, QER, a Forwarding Action Rule, FAR, or a Usage Reporting Rule, URR.

Preferably, the PFCP rules comprises at least one of: a QUIC traffic detection indication, an IP address and a port number of a user equipment for a QUIC connection, a QUIC connection identification used by the user equipment, a IP address and a port number of a remote server for the QUIC connection, or a QUIC connection identification used by the remote server.

Preferably, the QUIC traffic parameters are transmitted through a session management policy association update request message.

Preferably, the QUIC traffic parameters comprises at least one of: a transport protocol type setting to QUIC, an Internet Protocol, IP, address and a port number of a user equipment for a QUIC connection, a QUIC connection identification used by the user equipment, a IP address and a port number of a remote server for the QUIC connection, or a QUIC connection identification used by the remote server.

Preferably, the PCC rules are transmitted through a session management policy association update response message.

Preferably, the PCC rules are determined based on at least one of: the QUIC traffic parameters, local rules of the policy control node, rules retrieved from an external storage, or application service information from an application node.

Preferably, the method includes: transmitting, by the policy control node to an application node, the QUIC traffic parameters for the QUIC application; and receiving, by the policy control node from the application node, application service information for the QUIC application in response to the QUIC traffic parameters.

Preferably, the application service information comprises at least one of: an application identification, an application service type, an identification for a user equipment, a IP address and a port number of a user equipment for a QUIC connection, a QUIC connection identification used by the user equipment, a IP address and port numbers of a remote server for the QUIC connection, or a QUIC connection identification used by the remote server.

Preferably, the method includes: transmitting, by an application node to a policy control node, application service information for a quick UDP Internet connection, QUIC, application, to allow the policy control node to determine Policy and Charging Control, PCC, rules for a QUIC traffic detection.

Preferably, the application service information is transmitted through an application function session binding procedure.

Preferably, the transmission of the application service information is triggered by an application server or by QUIC traffic parameters from the policy control node.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of a network according to an embodiment of the present disclosure.

FIG. 3 shows a schematic diagram of a network according to an embodiment of the present disclosure.

FIG. 4 shows a schematic diagram of a procedure according to an embodiment of the present disclosure.

FIG. 5 shows a schematic diagram of a procedure according to an embodiment of the present disclosure.

FIG. 6 shows a schematic diagram of a procedure according to an embodiment of the present disclosure.

FIG. 7 shows a schematic diagram of a procedure according to an embodiment of the present disclosure.

FIG. 8 shows a schematic diagram of a procedure according to an embodiment of the present disclosure.

FIG. 9 shows a schematic diagram of a procedure according to an embodiment of the present disclosure.

FIG. 10 shows a schematic diagram of a procedure according to an embodiment of the present disclosure.

FIG. 11 shows a schematic diagram of an example of a wireless terminal according to an embodiment of the present disclosure.

FIGS. 12 to 16 show flowcharts of methods according to embodiments of the present disclosure.

### DETAILED DESCRIPTION

To enable the network to recognize which service the QUIC traffic is related to, this present document discloses a method used to enhance the 5G packet detection and forwarding model to make the network recognize the service related to the QUIC traffic, and thus make corresponding traffic handling policy.

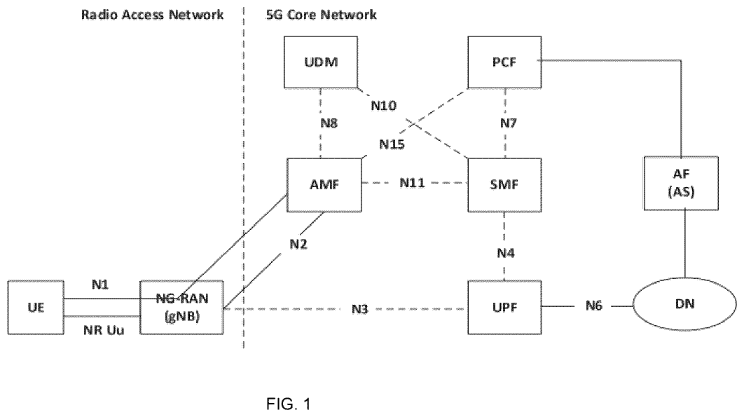

FIG. 1 shows a schematic diagram of a network (architecture) according to an embodiment of the present disclosure. In FIG. 1, the network comprises the following network functions/entities:

1) User Equipment (UE):

The UE corresponds to a mobile terminal accessing the network.

2) Next Generation Radio Access Network (NG-RAN):

In the 5G network, the NG-RAN is a new radio (NR) base station, also named gNB. In the present disclosure, the NG-RAN may be equal to NG-RAN node, RAN, or RAN node.

3) Access and Mobility Management function (AMF):

The AMF provides access management and mobility management for the UE, e.g. registration to network, registration during UE mobility, etc.

4) Session Management Function (SMF):

The SMF provides PDU session management for the UE, e.g. IP address allocation, QoS flow setup, etc.

5) User plane function (UPF):

The UPF provides IP traffic routing and forwarding management.

6) Policy Control Function (PCF):

The PCF provides QoS policy rules to control plane functions, to enforce the QoS Policy rules.

7) Application Function (AF):

The AF provides instructions for influencing the QoS policy rules to the PCF. In the present disclosure, the AF may be equal to an Application Server (AS).

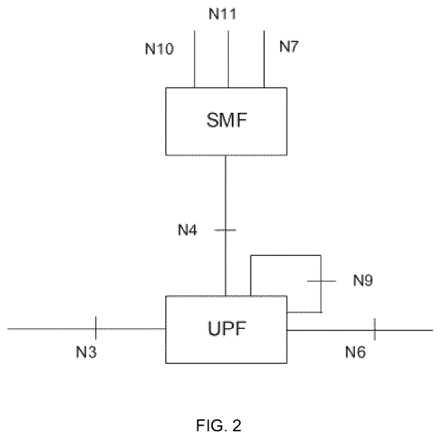

The Control and User Plane Separation (CUPS) is designed as native technology in the 5G network, as shown in FIG. 2. The CUPS separates the network function for handling data transmission to two separate parts: the Control Plane Function (i.e. CP Function), and the User Plane Function (i.e. UP Function). In 5G, the CP Function is the SMF, and the UP Function is the UPF.

The CUPS allows that the UPF only handles the user plane aspects of data traffic transmission (e.g. traffic detection, filtering, and forwarding, usage reporting, etc.), by receiving instructions from the SMF on how to handle the data traffic. The SMF only handles the control plane aspects of data transmission (e.g. PDU session establishment/modification/release, N4 session establishment/modification/release, generating Packet Forwarding Control Protocol, PFCP, rules for instructing the UPF on data traffic handling, etc.). On the N4 interface between the SMF and UPF, the PFCP rules are also named N4 rules.

FIG. 2 shows the CUPS architecture in the 5G system, where the CP Function is the SMF and the UP Function is the UPF.

In this architecture, there are the following network functions:

8) SMF (Session Management Function):

This SMF provides the following functionalities: session establishment, modification and release, UE IP address allocation and management (including optional authorization functions), selection and control of UP function, downlink data notification, etc. The SMF controls the UPF via N4 association.

9) UPF (User plane function):

This function includes the following functionalities: serving as an anchor point for intra-/inter-radio access technology (RAT) mobility, packet routing and forwarding, traffic usage reporting, QoS handling for the user plane, downlink packet buffering and downlink data notification triggering, etc.

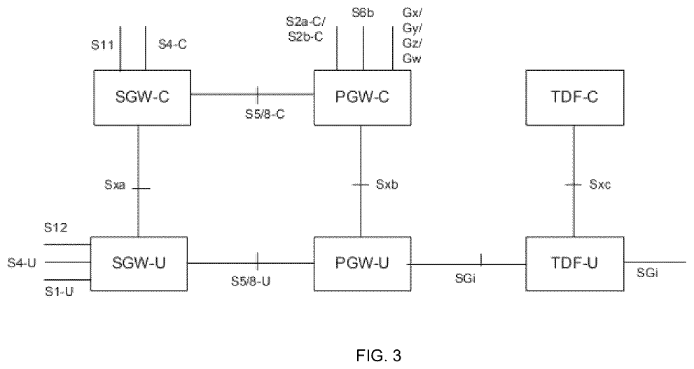

The CUPS is also applied to enhance the 4G network to allow the separation of user plane from the control plane for SGW and PGW, as shown in FIG. 3.

FIG. 3 shows the CUPS architecture in the 4G system, where the SGW-C/PGW

C/TDF-C act as the CP Function and the SGW-U/PGW-U/TDF-U acts as the UP Function.

In this architecture, there are the following network entities:

10) SGW (Serving Gateway):

The SGW terminates the user plane interface towards E-UTRAN (Evolved UMTS Terrestrial Radio Access Network), and provides mobility anchor during inter-eNodeB handover. The SGW-C(SGW Control Plane) controls the SGW-U (SGW User Plane) via the Sxa interface.

11) PGW (PDN Gateway):

The PDN GW is the gateway which terminates the SGi interface towards the PDN (Packet Data Network). The PGW allocates IP address for a UE, and provides IP traffic routing and forwarding functionality. The PGW-C(PGW Control Plane) controls the PGW-U (PGW User Plane) via the Sxb interface.

12) TDF (Traffic Detection Function):

The TDF provides the capability to detect traffic flow for specific service and application. The TDF-C(TDF Control Plane) controls the TDF-U (TDF User Plane) via the Sxc interface.

After the UE registers to the 5G network, the UE may request a PDU Session Establishment procedure towards the 5G network if requiring communications with an Application Server. During the PDU Session Establishment procedure, the 5G network assigns a default QoS flow for the UE and may additionally assign indicated QoS flow(s) for the UE according to the UE request and/or according to instructions from the policy configured for the UE.

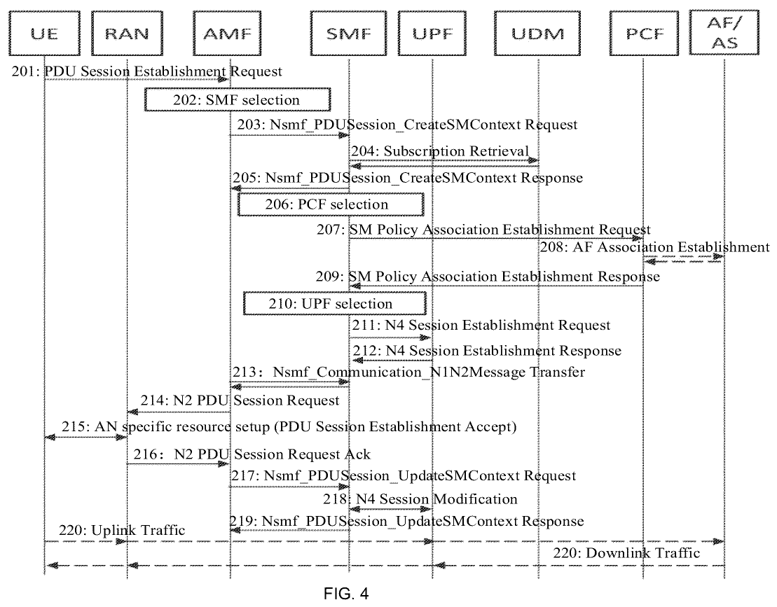

FIG. 4 shows a schematic diagram of a PDU Session Establishment procedure according to an embodiment of the present disclosure. In FIG. 4, the SMF assigns a set of QoS flows to guarantee communications between the UE and the Application Server (e.g. AF). Specifically, after the UE registers to the 5G network, the UE may request the PDU session establishment procedure and the PDU session establishment procedure comprises:

Step 201: The UE transmits, to the AMF, a NAS (Non-access stratum) Message (e.g. Single Network Slice Selection Assistance Information (S-NSSAI(s)), UE Requested Data Network Name (DNN), PDU Session ID, Request type, N1 session management (SM) container (e.g. PDU Session Establishment Request)).

The PDU Session Establishment Request is included in the NAS message and encapsulated in the N1 SM container. The NAS message sent by the UE is encapsulated by the RAN in an N2 message towards the AMF.

Step 202: The AMF selects a proper SMF (i.e. anchor SMF) to serve the PDU session based on the requested DNN, the S-NSSAI and the current UE location information.

Step 203: The AMF transmits, to the SMF, Nsmf_PDUSession_CreateSMContext Request (comprising Subscription Permanent Identifier (SUPI), selected DNN, UE requested DNN, S-NSSAI(s), PDU Session ID, AMF ID, Request Type, N1 SM container (comprising PDU Session Establishment Request), User location information, Access Type, radio access technology (RAT) Type, Permanent Equipment Identifier (PEI), Generic Public Subscription Identifier (GPSI)).

The SUPI uniquely identifies the UE subscription. The AMF ID carries Globally Unique AMF ID (GUAMI) uniquely identifying the AMF serving the UE.

Step 204: To serve the PDU session, the SMF retrieves session management subscription data from the UDM, in case it has not retrieved such information previously.

Step 205: The SMF transmits, to the AMF, Nsmf_PDUSession_CreateSMContext Response (comprising Cause, SM Context ID). The SM Context ID identifies the SM context created in the SMF for the UE.

Step 206: If dynamic policy and charging control (PCC) is configured to be used for the PDU Session, the SMF selects a proper PCF to serve the PDU session.

Step 207: The SMF sends an Npcf_PolicyAssociation_Create Request to the PCF, to perform an SM Policy Association Establishment procedure and to get the default PCC Rules for the PDU Session. Necessary parameters such as SUPI, PDU Session ID, DNN, S-NSSAI shall be provided in the request. Other parameters such as GPSI, UE IP address, UE External ID, RAT Type, Access Type, may also be provided in the request message.

Step 208: The PCF may interact with the AF to establish AF association. The AF association establishment allows the AF to dynamically influence the traffic model of the PDU session via the PCF, e.g. to establish new dedicated QoS flow or to modify the existing QoS flow.

Step 209: The PCF sends an Npcf_PolicyAssociation_Create Response to the SMF, to return the default PCC Rules for the PDU Session.

Step 210: The SMF selects an UPF acting as PDU Session Anchor (PSA).

Step 211: The SMF sends an N4 Session Establishment Request to the UPF to request establishing an N4 session for this PDU Session, carrying a set of PFCP rules for packet detection and QoS enhancement to be installed in the UPF. The PFCP rules include Packet Detection Rule (PDR), Forward Action Rule (FAR), QoS Enforcement Rule (QER), Usage Reporting Rule (URR), etc.

If the SMF receives the PCC rules from the PCF, the SMF maps the PCC rules to a set of QoS flows and generates a set of PFCP rules (i.e. PDR/FAR/QER/URR/etc. rules) accordingly to reflect the determined QoS flows.

The UPF installs these rules for this PDU session and uses these rules to filter the uplink/downlink traffic and performs corresponding QoS enhancement to the filtered uplink/downlink traffic.

Step 212: The UPF acknowledges by sending an N4 Session Establishment Response to the SMF.

Step 213: The SMF transmits, to the AMF, an Namf_Communication_N1N2MessageTransfer Request (comprising PDU Session ID, N2 SM information (PDU Session ID, QFI(s), QoS Profile(s), N3 CN Tunnel Info), N1 SM container (PDU Session Establishment Accept)).

The N2 SM information carries information which shall be forwarded by the AMF to the RAN. For example, the N2 SM information may comprise the N3 CN Tunnel Info carrying I-UPF UL F-TEID (Intermediate UPF Uplink Full Qualified Tunnel Endpoint Identifier), the QFIs and QoS profiles used by the RAN to set up QoS flows.

One or multiple QoS profiles and the corresponding QFIs are provided to the RAN, to allow the RAN to control the QoS flow and perform traffic detection and admission control at QoS flow level.

In an embodiment, the QoS profile comprises the following parameters:
QFI, used to uniquely identify one QoS flow in a PDU session;
ARP, indicates the Allocation and Retention Priority of the QoS flow;
GBR (guaranteed flow bit rate) QoS flow parameters, used by the RAN to control the QoS flow, such as Maximum Flow Bit Rate Downlink, Maximum Flow Bit Rate Uplink, Guaranteed Flow Bit Rate Downlink, Guaranteed Flow Bit Rate Uplink, Maximum Packet Loss Rate Downlink, Maximum Packet Loss Rate Uplink, etc.;

The N1 SM container comprises the PDU Session Establishment Accept that the AMF shall provide to the UE. Within the PDU Session Establishment Accept, the following parameters are included: PDU session ID, PDU session type, UE IP address, one or multiple QoS rules, QoS Flow level QoS parameters associated to those QoS rule(s), DNN, S-NSSAI, etc.

Step 214: The AMF transmits, to the RAN, an N2 PDU Session Request (comprising N2 SM information, NAS message (PDU Session ID, N1 SM container (PDU Session Establishment Accept))). The AMF sends the NAS message containing PDU Session ID and PDU Session Establishment Accept targeted to the UE and the N2 SM information received from the SMF within the N2 PDU Session Request to the RAN.

Step 215: The RAN may issue AN (Access Network) specific signaling exchange with the UE that is related with the information received from SMF. For example, in case of a 3GPP RAN, a RRC Connection Reconfiguration may take place with the UE establishing the necessary RAN resources related to the QoS Rules for the PDU Session request. RAN forwards the NAS message (PDU Session ID, N1 SM container (PDU Session Establishment Accept)) to the UE. RAN also allocates AN N3 tunnel information for the PDU Session.

Step 216: The RAN transmits, to the AMF, an N2 PDU Session Response (comprising PDU Session ID, Cause, N2 SM information (PDU Session ID, AN Tunnel Info, List of accepted/rejected QFI(s))).

In an embodiment, the AN Tunnel Info corresponds to the Access Network address of the N3 tunnel corresponding to the PDU Session.

Step 217: The AMF transmits, to the SMF, an Nsmf_PDUSession_UpdateSMContext Request (N2 SM information). The AMF forwards the N2 SM information received from RAN to the SMF. If the list of rejected QFI(s) is included in the N2 SM information, the SMF releases the rejected QFI(s) associated QoS profiles.

Step 218: The SMF initiates an N4 Session Modification procedure with the UPF. The SMF provides AN Tunnel Info to the UPF as well as the corresponding forwarding rules.

Step 219: The SMF sends an Nsmf_PDUSession_UpdateSMContext Response to the AMF.

Step 220: The UE initiates uplink traffic transmission(s) (e.g. towards its Application Server) or receives downlink traffic (e.g. from its Application Server).

During the PDU Session Establishment procedure, the SMF allocates the default QoS flow to the UE for the PDU session. The SMF may also allocate dedicated QoS flows for the PDU session, if the SMF is instructed by the locally configured PCC rules (e.g. associated to the DNN, S-NSSAI), or instructed by the dynamic PCC rules from the PCF.

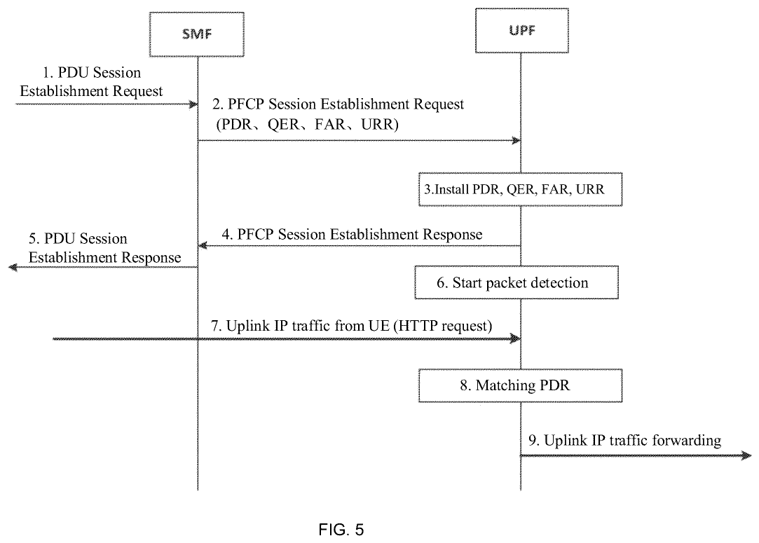

To specify the procedure between the SMF and UPF during the PDU Session Establishment (i.e. steps 211 and 212 in FIG. 4), FIG. 5 further shows the PFCP Session Establishment procedure between the SMF and UPF to setup the N4 session.

During the PFCP Session Establishment/Modification procedure, the SMF provides the necessary information to the UPF, to instruct the UPF to perform packet detection and forwarding.

1. The SMF is triggered to establishment PFCP session to the UP Function. The trigger is the PDU session establishment request message from the AMF.

The SMF selects a proper UP Function, based on DNN, S-NSSAI and other necessary information.

2. The SMF sends PFCP Session Establishment Request to the selected UP Function, carrying the PDR, QER, FAR, URR.

The PDR (Packet Detecting Rule) defines the packet filters for service data flows, e.g. to filter out the uplink/downlink traffic from/to a specific application (e.g. HTTP message to a specific website).

In the PDR, one or more SDF (Service Data Flow) Filter may be used to express the packet filter for specific service data flow.

The QER (QOS Enforcement Rule), which is associated to at least one PDR, defines how to control the QoS of the detected service flow.

The FAR (Forwarding Action Rule), which is associated to at least one PDR, defines how to route and forward the detected service flow. For example, MEC (Multi-access Edge Computing) traffic may be required to route to local servers.

The URR (Usage Reporting Rule), which is associated to at least one PDR, defines how to report the volume/time usage of the detected service flow, and how to report the usage to the CP Function.

3. Upon receiving the PFCP Session Establishment request from the SMF, the UPF installs the received rules (i.e. PDR/QER/FAR/URR) for this PFCP session.

4. The UPF sends back the PFCP Session Establishment Response message to the SMF.

5. The SMF responds to the trigger entity (e.g. AMF) of the PDU session establishment, by sending the PDU Session Establishment Response message.

6. The UPF starts to detect the uplink/downlink traffic from/to the UE, and tries to match the receiving IP packets with the PDR(s). If incoming IP packets match one PDR, the corresponding QER/URR/FAR can be performed.

7. Later, the UE initiates uplink traffic towards the server. For example, the UE sends a HTTP request to the dedicated Web Server.

8. The UPF inspects the uplink traffic from the UE, and detects whether it matches one of the installed PDRs. For example, the uplink traffic (HTTP request from the UE) matches the PDR targeting to detect the HTTP request from the UE.

For certain IP traffic (e.g. HTTP traffic), some specific actions might be required before the UPF forwards the IP traffic. For example, HTTP header enrichment might be required by the SMF.

9. As per the instruction of the FAR rule, the UPF sends the IP packets onwards. The IP packets might be altered by the UPF based on the instruction from the SMF, e.g. HTTP header enrichment might be performed to HTTP traffic.

On the demand of application traffic transmission, a PDU Session Modification procedure may be initiated by the UE or the PCF, to request the SMF to allocate dedicated QoS flows for the PDU session. The SMF retrieves updated PCC rules from the PCF and allocates the dedicated QoS flows accordingly. After allocating the dedicated QoS flows, the SMF sends the N2 SM information to the RAN, to update the QFIs and the QoS profiles stored in the RAN. The SMF also sends the N1 SM Container to the UE, to update the QoS flows and the QoS rules stored in the UE.

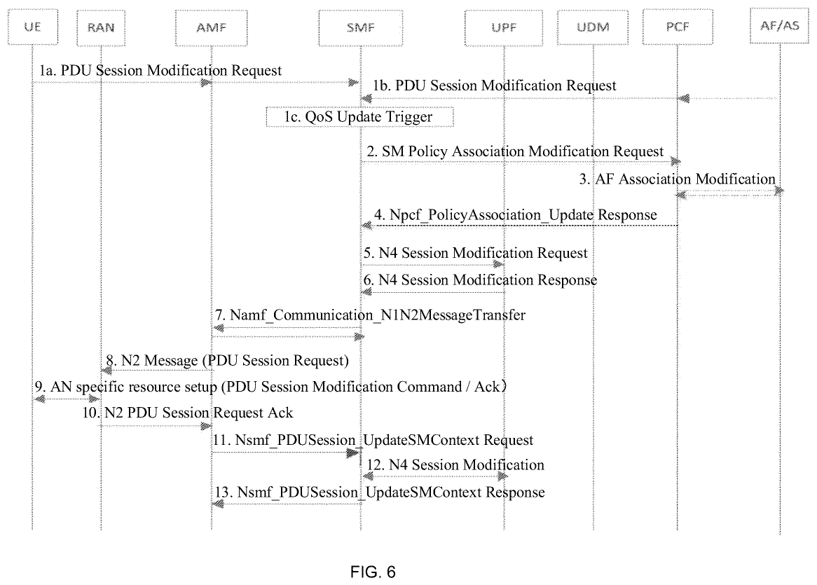

FIG. 6 describes the PDU Session Modification procedure, which might be triggered by the UE, the PCF, or the SMF. Other network functions (e.g. the UDM, the RAN, or the AMF) may also trigger the PDU Session Modification procedure in certain scenarios.

1. The PDU Session Modification procedure may be triggered by at least one of the events described in steps 1a, step 1b, and/or step 1c.

1a. The UE initiates the PDU Session Modification procedure by the transmission of an NAS message (N1 SM container (PDU Session Modification Request), PDU Session ID). The NAS message is forwarded by the RAN to the AMF. The AMF invokes Nsmf_PDUSession_UpdateSMContext (SM Context ID, N1 SM container (PDU Session Modification Request)).

1b. The PCF performs a PCF initiated SM Policy Association Modification procedure to notify SMF about the modification of policies. This may be triggered by a policy decision or upon AF requests, e.g. Application Function influence on traffic routing.

1c. The SMF may decide to modify a PDU Session. This procedure may also be triggered based on a locally configured policy or triggered from the RAN. It may also be triggered if the UP connection is activated and the SMF has marked that the status of one or more QoS flows are deleted in the 5GC but not synchronized with the UE yet.

2. The SMF may initiate a SM Policy Association Modification procedure towards the PCF, if PDU Session Modification procedure is not triggered by the PCF. The SMF sends Npcf_PolicyAssociation_Update Request to the PCF, to retrieve the updated QoS rules from the PCF.

3. For a specific service, the PCF may interact with the AF to update the AF association. The AF may send dynamical traffic authorization to this PDU session.

4. The PCF sends Npcf_PolicyAssociation_Update Response to the SMF, to return the updated PCC Rules for the PDU Session.

5. The SMF sends an N4 Session Modification Request to the UPF to request modification N4 session for this PDU Session, carrying a set of PFCP rules for packet detection and QoS enhancement to be installed in the UPF. The PFCP rules include Packet Detection Rule (PDR), Forward Action Rule (FAR), QOS Enforcement Rule (QER), Usage Reporting Rule (URR), etc.

The SMF maps the updated PCC rules received from the PCF to a set of QoS flows, and generates a set of updated PFCP rules (i.e. PDR/FAR/QER/URR/etc. rules) accordingly to reflect the updated QoS flows.

The UPF installs these updated PFCP rules for this PDU session, and uses these rules to filter the uplink/downlink traffic and performs corresponding QoS enhancement to the filtered uplink/downlink traffic.

6. The UPF acknowledges by sending an N4 Session Modification Response.

7. SMF to AMF: Namf_Communication_N1N2Message Transfer Request (PDU Session ID, N2 SM information (PDU Session ID, QFI(s), QoS Profile(s), N3 CN Tunnel Info), N1 SM container (PDU Session Modification Command)).

8. AMF to RAN: N2 PDU Session Request (N2 SM information, NAS message (PDU Session ID, N1 SM container (PDU Session Modification Command))). The AMF sends the NAS message containing PDU Session ID and PDU Session Modification Command targeted to the UE and the N2 SM information received from the SMF within the N2 PDU Session Request to the RAN.

9. RAN to UE: The RAN may issue AN specific signaling exchange with the UE that is related with the information received from SMF.

10. RAN to AMF: N2 PDU Session Response (PDU Session ID, Cause, N2 SM information (PDU Session ID, AN Tunnel Info, List of accepted/rejected QFI(s))).

11. AMF to SMF: Nsmf_PDUSession_UpdateSMContext Request (N2 SM information).

The AMF forwards the N2 SM information received from RAN to the SMF. If the list of rejected QFI(s) is included in N2 SM information, the SMF shall release the rejected QFI(s) associated QoS profiles.

12. The SMF initiates an N4 Session Modification procedure with the UPF. The SMF provides RAN Tunnel Info to the UPF as well as the corresponding forwarding rules.

13. The SMF sends an Nsmf_PDUSession_UpdateSMContext Response to the AMF.

In some embodiments, in the above procedure, the UPF may not be able to get any instruction from the SMF on whether detection of QUIC traffic is needed, and/or how to apply specific handling (e.g. QoS control, traffic forwarding) to the QUIC traffic. However, some QUIC applications may have specific QoS requirements, which require the network to correctly handle the QUIC traffic.

To support these service requirements, some embodiments of the present disclosure provide a method to allow the network to correctly handle the QUIC traffic.

### Aspect 1: UPF Feature for Supporting QUIC Traffic Handling

In some embodiments, during the PFCP Association Setup procedure, the UPF can provide its QUIC traffic handling capability to the SMF. With the UPF provided capability, the SMF can thus request the UPF to detect the QUIC traffic and perform certain operations for the QUIC traffic.

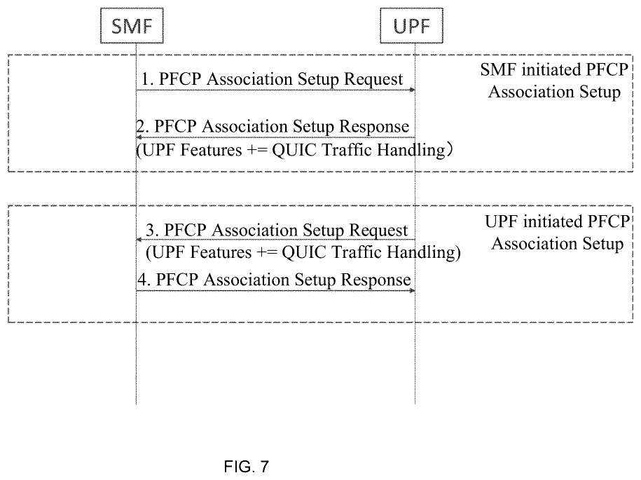

FIG. 7 shows a schematic diagram of a procedure according to an embodiment of the present disclosure. In FIG. 7, the QUIC support negotiation during the PFCP Association is illustrated. Different types of setup (e.g., SMF-initiated or UPF-initiated) are described in the following paragraphs.

For SMF initiated PFCP Association Setup, steps 1 and 2 are executed:

1. The SMF sends the PFCP Association Setup Request to the UPF.

2. The UPF accepts the PFCP Association setup, and sends a PFCP Session Association Setup Response message to the SMF. Within the message, the QUIC Traffic Handling support indication may be carried in the UPF Features IE (Information Element). For UPF initiated PFCP Association Setup, steps 3 and 4 are executed:

3. The UPF sends the PFCP Association Setup Request message to the SMF. Within the message, the QUIC Traffic Handling support indication may be carried in the UPF Features IE.

4. The SMF accepts the PFCP Association setup, and sends a PFCP Association Setup Response to the UPF.

### Aspect 2: Instruct the UPF to Detect QUIC Traffic, and Report QUIC Traffic Detection

In some embodiments, during the PFCP Session Establishment procedure, the SMF can instruct the UPF to detect QUIC traffic and report QUIC traffic detection.

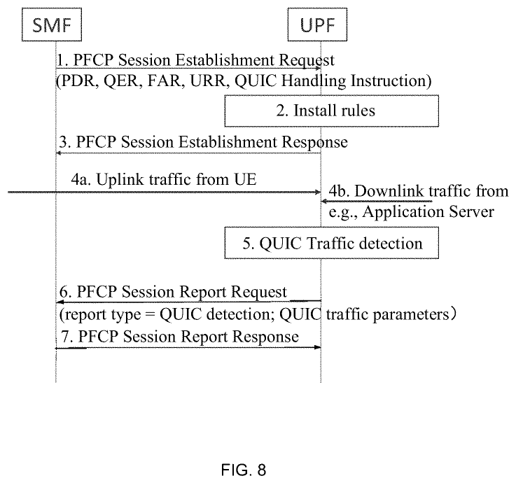

FIG. 8 shows a schematic diagram of a procedure according to an embodiment of the present disclosure. In FIG. 8, the SMF providing instruction for QUIC traffic detection to the UPF during the PFCP Session Establishment procedure is illustrated.

1. The SMF sends the PFCP Session Establishment Request to the selected UPF, carrying the PFCP rules (i.e. PDR/QER/FAR/URR/etc. rules).

In the request, the SMF further sends the QUIC Handling Instruction to the UPF. The QUIC Handling Instruction may be included in the PDR. The QUIC Handling Instruction may contain: QUIC Traffic Detection Indication, which indicates to the UPF that QUIC traffic detection is required. The QUIC Handling Instruction may contain: QUIC Traffic Report Indication, which instructs the UPF to report the detection of QUIC traffic once QUIC traffic is detected.

2. Upon receiving the PFCP Session Establishment request from the SMF, the UPF installs the received PFCP rules (i.e. PDR/QER/FAR/URR/etc. rules) for this PFCP session.

If the UPF supports the feature of QUIC Traffic Handling, and the QUIC Handling Instruction is provided, the UPF may store the QUIC Handling Instruction, and perform QUIC traffic handling as required.

3. The UPF sends a PFCP Session Establishment Response message to the SMF.

4a/4b. Later, the uplink/downlink traffic arrives at the UPF.

5. The UPF performs QUIC traffic detection as required, and collects the QUIC traffic parameters.

The UPF recognizes QUIC traffic parameters from the QUIC header of the QUIC traffic. The UPF may be able to detect at least one of the following QUIC traffic parameters from the QUIC protocol header:
Transport protocol type, which is QUIC;
UE IP address and port(s), used by the UE to send/or receive QUIC traffic; and/or
Remote Server IP address and port(s), used by the remote server to send/receive QUIC traffic.

The UPF may also be able to recognize the QUIC Connection ID(s) from the QUIC protocol header. The QUIC Connection ID(s) is used to uniquely identify one QUCI connection between two endpoints (e.g. the UE and the remote server). The QUIC Connection ID used by the UE for sending uplink QUIC traffic is different from the QUIC Connection ID used by the Remote Server for sending downlink QUIC traffic. The UPF may be able to recognize the different QUIC Connection IDs.

If QUIC traffic is detected, the UPF may report the QUIC traffic detection to the SMF, when the QUIC traffic report is required by the SMF (i.e. when the QUIC Traffic Report Indication is set to true in step 1).

6. The UPF sends the PFCP Session Report request to the SMF. In the report, the report type is set to “QUIC Detection”. The QUIC traffic parameters are also included in the report, carrying at least one of the following QUIC parameters: transport protocol type setting to QUIC, UE IP address and port(s), remote server IP address and port(s), and/or QUIC Connection ID(s).

7. The SMF sends the PFCP Session Report response to the UPF.

After step 7, the SMF may use the reported QUIC traffic parameters to request the PCF to provide updated PCC rules accordingly. The SMF may use the updated PCC rules to generate updated PFCP rules.

### Aspect 3: Retrieve PCC Rules for QUIC Application

In some embodiments, the SMF may request the PCF to provide PCC rules for a specific QUIC application, e.g. when it receives PFCP session report on QUIC traffic detection.

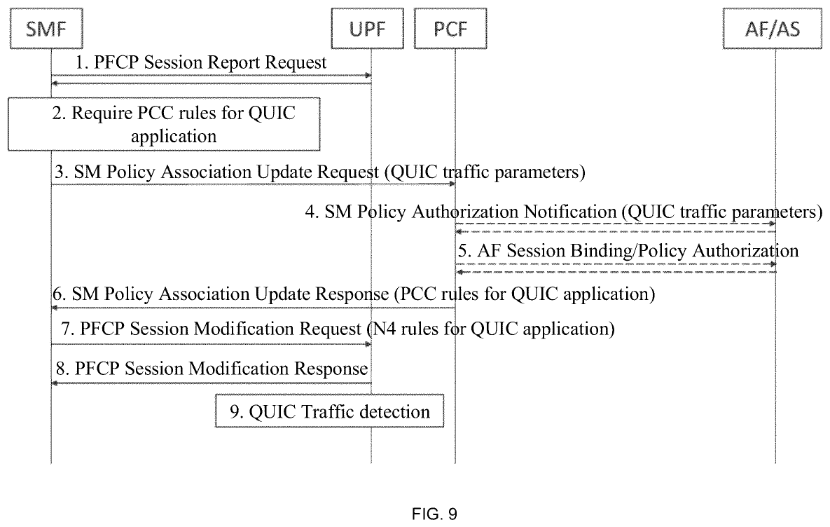

FIG. 9 shows a schematic diagram of a procedure according to an embodiment of the present disclosure. In FIG. 9, the SMF providing instruction for QUIC traffic detection to the UPF during the PFCP Session Establishment is illustrated.

1. The SMF receives the PFCP Session Report from the UPF. The report type is set to “QUIC Detection” and the QUIC traffic parameters are included in the report.

2. The SMF determines that the PCC rules for the QUIC application are required. If dynamic PCC is implemented, the SMF needs to retrieve the PCC rules for the QUIC application from the PCF. Otherwise, the SMF may use local configured rules to generate PCC rules for the QUIC application.

3. If dynamic PCC is implemented, the SMF sends SM Policy Association Update request to the PCF, carrying the QUIC traffic parameters.

The QUIC traffic parameters include at least one of the followings: Transport protocol type setting to QUIC, UE IP address and port(s), QUIC Connection ID used by the UE, Remote Sever IP address and port(s), and/or QUIC Connection ID used by the Remote Server.

The PCF uses said QUIC traffic parameters provided by the SMF to generate new PCC rules for the QUIC application.

The PCF may be configured with local rules to recognize various QUIC applications, or may retrieve such rules from external storage, e.g. the UDR (Unified Data Repository). In an embodiment, the PCF may generate PCC rules for the QUIC application based on the rules the PCF retrieved and the QUIC traffic parameters provided by the SMF.

Or, the PCF may be configured to contact the corresponding AF to report the QUIC traffic detection, and collect policy authorization from the AF. In this case, The PCF may generate PCC rules for the QUIC application based on the application service information from the AF and the QUIC traffic parameters provided by the SMF.

4. The PCF may send the Policy Authorization Notification to the AF, carrying the QUIC traffic parameters. The AF may verify the QUIC traffic parameters and determines to initiate AF session binding to the PCF.

5. Upon receiving the Policy Authorization Notification from the PCF, the AF may initiate AF Session Binding procedure to the PCF, and provide the application service information for QUIC to the PCF.

The application service information for QUIC may contain at least one of the followings:
Application ID, identifying the QUIC application;
Application Service ID, identifying the service of the QUIC application;
UE ID, indicating the user identifier, e.g. SUPI (Subscription Permanent Identifier) or GPSI (Generic Public Subscription Identifier);
UE IP address and port(s), indicating the IP address and port(s) used by the UE to set up the QUIC connection;
Remote Server IP address and port(s), indicating the IP address and port(s) used by the remote server to set up the QUIC connection; and/or
QUIC ID(s), which may contain the QUIC Connection ID(s) identifying the QUIC connection between the UE and the remote server.

6. The PCF sends the SM Policy Association Update response to the SMF, carrying the PCC rules for the QUIC application.

The PCF generates the PCC rules for the QUIC application based on the application service information provided by the AF.

The PCC rules for the QUIC application may contain at least one of the followings:
1) the application information, which may include at least one of: the Application ID and/or the Application Service Type;
2) the flow description identifying an QUIC connection, which may include at least one of: the QUIC Connection IDs, the UE IP address and UDP port, and/or the remote server IP address and UDP port; and/or
3) the QoS parameters associated to the flow, which may include at least one of: QoS Flow Identifier (QFI), Allocation and Retention Priority (ARP), Maximum Bandwidth of UL/DL, and/or Guaranteed Bandwidth of UL/DL, etc.

7. Upon receiving the PCC rules for the QUIC application, the SMF generates the corresponding PFCP rules (i.e. PDR/QER/FAR/URR/etc. rules) for the QUIC application, and sends the PFCP Session Modification Request to the UPF, carrying the updated PFCP rules.

In an embodiment, in this step, at least one PDR rule for the QUIC traffic detection is created.

In an embodiment, in this step, one or more QER/FAR/URR rules for QUIC traffic are created and linked to the PDR rule(s) for QUIC traffic detection mentioned above.

In an embodiment, at least of one of the followings may be carried in the PFCP rules (e.g. in the PDR) to instruct the UPF to detect the specific QUIC traffic:
QUIC Traffic Detection indication, to instruct the UPF to detect QUIC traffic;
QUIC Connection ID(s), to instruct the UPF to detect the QUIC traffic over the indicated QUIC connection;
the UE IP address and port(s), to instruct the UPF to detect the QUIC traffic from/to that UE address; and/or
the Remote Server IP address and port(s), to instruct the UPF to detect QUIC traffic from/to that remote server address.

8. The UPF receives the PFCP Session Modification Request, updates the received PFCP rules (i.e. PDR/QER/FAR/URR/etc. rules) to its storage.

9. Based on the updated PFCP rules, the UPF starts to detect QUIC traffic for the specific QUIC application, and performs required actions (e.g. gateway control, QoS enforcement, forwarding, usage reporting, etc.) on the detected QUIC traffic.

### Aspect 4: AF Influences the QUIC Traffic Handling

In some embodiments, when the UE has set up a QUIC connection to the remote server, the remote server (acting as AF, or connected to an AF) may perform an application session binding procedure to the PCF to influence the QUIC traffic handling, directly or via an AF.

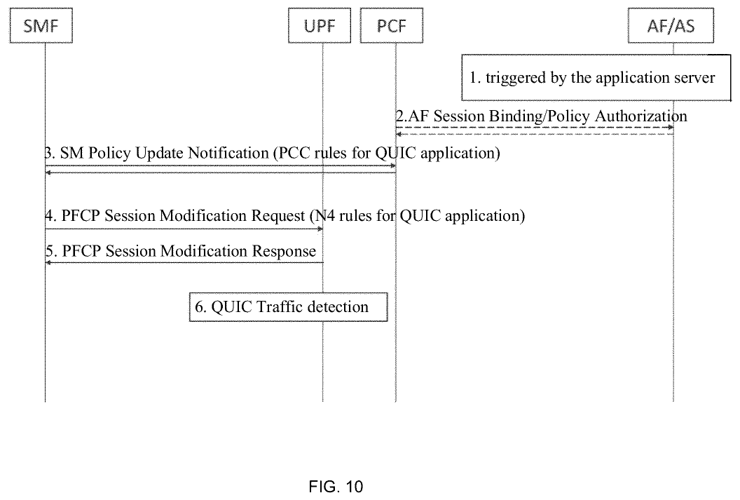

FIG. 10 shows a schematic diagram of a procedure according to an embodiment of the present disclosure. In FIG. 10, the AF performing application session binding procedure to the PCF to influence the QUIC traffic handling is illustrated.
1. The AF may be triggered by the application server, to perform application session binding for QUIC application.
2. The AF initiates the AF Session Binding procedure to the PCF, and provides the application service information for QUIC to the PCF. Details of this step can be referred to step 5 of Aspect 3.
3. The PCF initiates the SM Policy Update Notification procedure to the SMF, carrying the PCC rules for the QUIC application.

The PCF generates the PCC rules for the QUIC application based on the application service information provided by the AF.

Steps 4 to 6 are similar to steps 7 to 9 of Aspect 3, and details of these steps can be ascertained by referring to the embodiments described above.

According to the procedures described above, the SMF can instruct the UPF to detect certain QUIC traffic, and perform correct actions to the detected QUIC traffic.

In some embodiments, steps in the aspects described above can be combined with each other. For example, step 2 or 3 in Aspect 1 can be performed before step 1 in Aspect 2 to allow the SMF to receive the QUIC Traffic Handling support indication. According to the QUIC Traffic Handling support indication, the SMF can send the QUIC Handling Instruction to the UPF.

As another example, steps 3 to steps 6 in Aspect 3 can be performed to allow the SMF to receive the PCC rules, so that the SMF can generate the PFCP rules according to the received PCC rules and transmit the PFCP rules to the UPF in step 1 in Aspect 2 or step 7 in Aspect 3.

Many aspects of the present disclosure are described below.

### <SMF, QUIC Traffic Instruction>

1. A method of QUIC traffic handling, applied to an SMF, includes:

receiving, QUIC Traffic Handling support indication from the UPF; and

sending, QUIC Traffic Instruction to the UPF.

2. Following item 1 above, the QUIC Traffic Instruction includes at least one of: a QUIC Traffic Detection Indication or a QUIC Traffic Reporting Indication.

3. Following item 1 above, receiving QUIC Traffic Handling supporting indication from the UPF can be: receiving QUIC Traffic Handling support indication from the UPF during PFCP Association Setup procedure.

4. Following item 1 above, sending QUIC Traffic Instruction to the UPF can be: sending QUIC Traffic Instruction to the UPF during the PFCP Session Establishment procedure.

### <UPF, Reporting QUIC Traffic Detection>

1. A method of QUIC traffic handling, applied to an UPF, includes:

receiving, QUIC Traffic Instruction from the SMF; and

sending, QUIC traffic detection report to the SMF.

2. Following item 1 above, the QUIC Traffic Instruction includes at least one of: a QUIC Traffic Detection Indication or a QUIC Traffic Reporting Indication.

3. Following item 1 above, sending QUIC traffic detection report can be: sending PFCP Session Report to the SMF, by setting the report type to QUIC traffic detection, and carrying QUIC Traffic Parameters.

4. Following item 3 above, the QUIC traffic parameters comprise at least one of: Transport protocol type setting to QUIC;
UE IP address and UDP ports used for QUIC connection;
QUIC Connection ID used by the UE;
Remote Server IP address and UDP ports used for QUIC connection; and/or
QUIC Connection ID used by the remote server.
   <SMF, Retrieves PCC Rules for QUIC from PCF>

1. A method of QUIC traffic handling, applied to an SMF, includes:

sending, QUIC traffic parameters, to the PCF;

receiving, PCC rules for QUIC application, from the PCF;

2. Following item 1 above, sending QUIC traffic parameters can be: sending SM Policy Association Update Request message to the PCF, carrying the QUIC traffic parameters.

3. Following item 1 or 2 above, the QUIC traffic parameters comprise at least one of:

Transport protocol type setting to QUIC;

UE IP address and ports used for QUIC connection;

QUIC Connection ID used by the UE;

Remote Server IP address and ports used for QUIC connection; or QUIC Connection ID used by the remote server.

### <PCF, Sends PCC Rules for QUIC to SMF>

1. A method of QUIC traffic handling, applied to a PCF, includes:

sending, PCC rules for QUIC application, to the SMF;

2. Following item 1 above, before sending PCC rules for QUIC application to the SMF, the method comprises: receiving QUIC traffic parameters from the SMF;

3. Following item 2 above, the QUIC traffic parameters comprises at least one of:
Transport protocol type setting to QUIC;
UE IP address and ports used for QUIC connection;
QUIC Connection ID used by the UE;
Remote Server IP address and ports used for QUIC connection; and/or
QUIC Connection ID used by the remote server.

4. Following item 1 above, before sending PCC rules for QUIC application to the SMF, the method comprises: receiving application session information for QUIC application from the AF.

5. Following item 4 above, the application session information for QUIC application comprises at least one of:
Application ID, identifies the QUIC application;
Application Service ID, identifies the service of the QUIC application;
UE ID, indicates the user identifier, e.g. SUPI or GPSI;
UE IP address and port(s), indicates the IP address and port(s) used by the UE to set up the QUIC connection;
Remote Server IP address and port(s), indicates the IP address and port(s) used by the remote server to set up the QUIC connection; and/or
QUIC ID, contains the QUIC Connection ID(s) identifying the QUIC connection between the UE and the remote server.

### <AF, Sends Application Session Information for QUIC to PCF>

1. A method of QUIC traffic handling, applied to an AF, includes:

sending, application session information for QUIC application, to the PCF.

2. Following item 1 above, the application session information for QUIC application comprises at least one of:
Application ID, identifies the QUIC application;
Application Service ID, identifies the service of the QUIC application;
UE ID, indicates the user identifier, e.g. SUPI or GPSI;
UE IP address and port(s), indicates the IP address and port(s) used by the UE to set up the QUIC connection;
Remote Server IP address and port(s), indicates the IP address and port(s) used by the remote server to set up the QUIC connection; and/or
QUIC ID, contains the QUIC Connection ID(s) identifying the QUIC connection between the UE and the remote server.

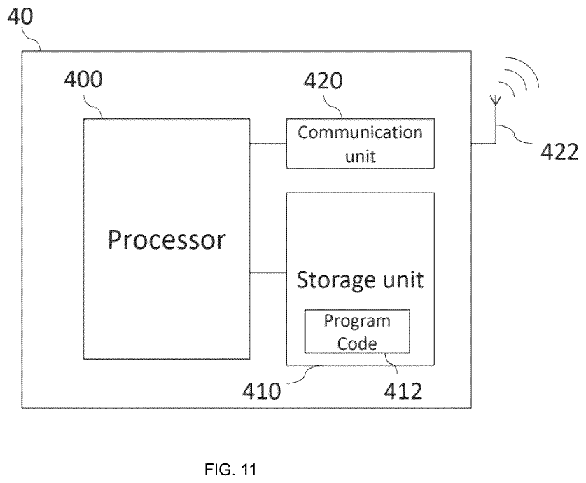

FIG. 11 relates to a schematic diagram of a wireless communication node 40 (e.g., a network device) according to an embodiment of the present disclosure. The wireless communication node 40 may be a satellite, a base station (BS) (e.g., a gNB or a gNB-CU-CP), a network entity, a Mobility Management Entity (MME), Serving Gateway (SGW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user plane function (UPF), a policy control function (PCF), an application function (AF), an application server (AS), an Unified Data Management (UDM), a network slice Selection Function (NSSF) etc. The wireless communication node 40 may include a processor 400 such as a microprocessor or ASIC, a storage unit 410 and a communication unit 1120. The storage unit 410 may be any data storage device that stores a program code 412, which is accessed and executed by the processor 400. Examples of the storage unit 410 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 110, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node and/or a wireless communication terminal.

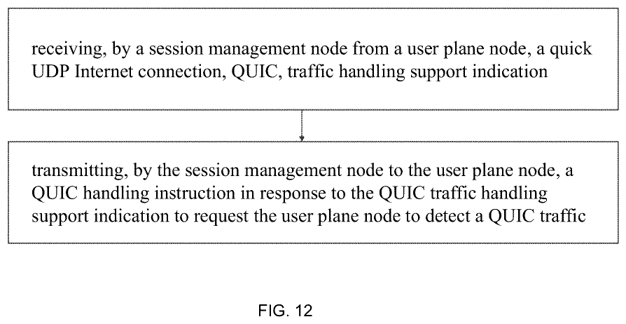

FIG. 12 shows a flowchart of a method according to an embodiment of the present disclosure. The method shown in FIG. 12 may be used in a wireless network node (e.g. SMF, a wireless network node comprising the SMF, a wireless network node performing at least part of functionalities of SMF) and comprises: receiving, by a session management node (e.g., SMF) from a user plane node (e.g., UPF), a quick UDP Internet connection, QUIC, traffic handling support indication; and transmitting, by the session management node to the user plane node, a QUIC handling instruction in response to the QUIC traffic handling support indication to request the user plane node to detect a QUIC traffic.

Details of this method can be ascertained by referring to embodiments described above.

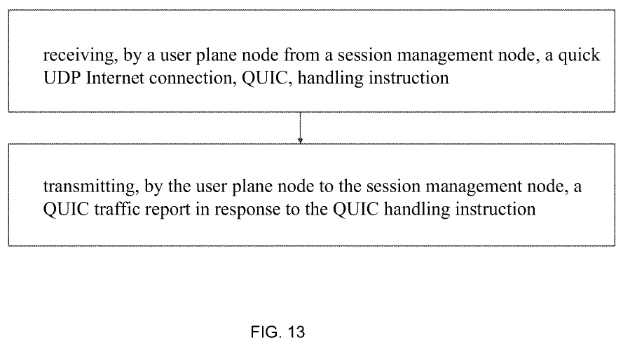

FIG. 13 shows a flowchart of a method according to an embodiment of the present disclosure. The method shown in FIG. 13 may be used in a wireless network node (e.g. UPF, a wireless network node comprising the UPF, a wireless network node performing at least part of functionalities of UPF) and comprises: receiving, by a user plane node (e.g., UPF) from a session management node (e.g., SMF), a quick UDP Internet connection, QUIC, handling instruction; and transmitting, by the user plane node to the session management node, a QUIC traffic report in response to the QUIC handling instruction.

Details of this method can be ascertained by referring to embodiments described above.

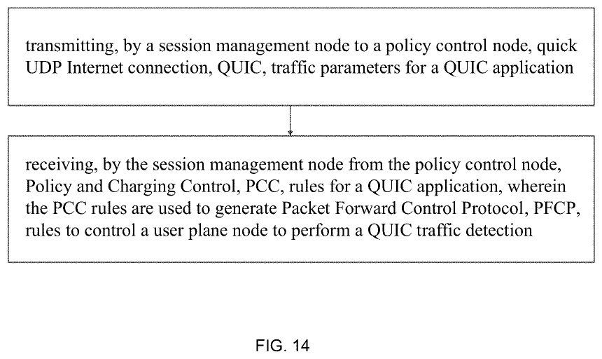

FIG. 14 shows a flowchart of a method according to an embodiment of the present disclosure. The method shown in FIG. 14 may be used in a wireless network node (e.g. SMF, a wireless network node comprising the SMF, a wireless network node performing at least part of functionalities of SMF) and comprises: transmitting, by a session management node (e.g., SMF) to a policy control node (e.g., PCF), quick UDP Internet connection, QUIC, traffic parameters for a QUIC application; and receiving, by the session management node from the policy control node, Policy and Charging Control, PCC, rules for a QUIC application, wherein the PCC rules are used to generate Packet Forward Control Protocol, PFCP, rules to control a user plane node to perform a QUIC traffic detection.

Details of this method can be ascertained by referring to embodiments described above.

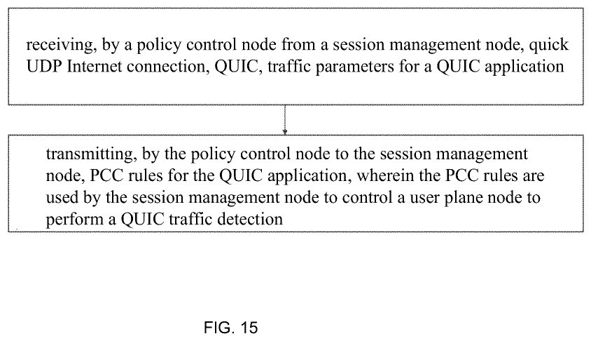

FIG. 15 shows a flowchart of a method according to an embodiment of the present disclosure. The method shown in FIG. 15 may be used in a wireless network node (e.g. PCF, a wireless network node comprising the PCF, a wireless network node performing at least part of functionalities of PCF) and comprises: receiving, by a policy control node (e.g., PCF) from a session management node (e.g., SMF), quick UDP Internet connection, QUIC, traffic parameters for a QUIC application; and transmitting, by the policy control node to the session management node, PCC rules for the QUIC application, wherein the PCC rules are used by the session management node to control a user plane node to perform a QUIC traffic detection (e.g., the session management node may generate PFCP rules to control the user plane node to perform the QUIC traffic detection).

Details of this method can be ascertained by referring to embodiments described above.

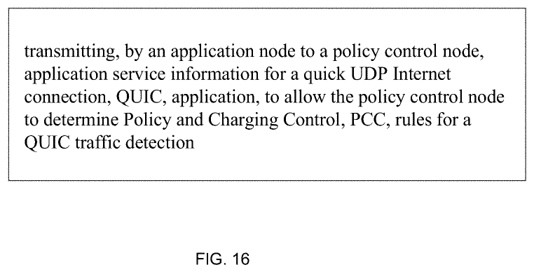

FIG. 16 shows a flowchart of a method according to an embodiment of the present disclosure. The method shown in FIG. 16 may be used in a wireless network node (e.g. AF, a wireless network node comprising the AF, a wireless network node performing at least part of functionalities of AF) and comprises: transmitting, by an application node (e.g., AF) to a policy control node (e.g., PCF), application service information for a quick UDP Internet connection, QUIC, application, to allow the policy control node to determine Policy and Charging Control, PCC, rules for a QUIC traffic detection.

Details of this method can be ascertained by referring to embodiments described above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a session management node from a user plane node, a quick UDP Internet connection: (QUIC): traffic handling support indication; and
transmitting, by the session management node to the user plane node, a QUIC handling instruction in response to the QUIC traffic handling support indication to request the user plane node to detect a QUIC traffic.

2. The wireless communication method of claim 1, wherein the QUIC handling instruction comprises at least one of a QUIC traffic detection indication, or a QUIC traffic reporting indication, wherein the QUIC traffic detection indication indicates to the user plane node that a QUIC traffic detection is required, and wherein the QUIC traffic reporting indication instructs the user plane node to report a detection of a QUIC traffic.

3. The wireless communication method of claim 1, wherein the QUIC traffic handling support indication is received through a Packet Forwarding Control Protocol; (PFCP); association setup request.

4. The wireless communication method of claim 1, wherein the QUIC handling instruction is transmitted through a PFCP session establishment request.

5. The wireless communication method of claim 1, further comprising:
receiving, by the session management node from the user plane node, a QUIC detection report comprising QUIC traffic parameters comprising at least one of: a transport protocol type setting to QUIC, an Internet Protocol-(IP): address and a port number of a user equipment for a QUIC connection, a QUIC connection identification used by the user equipment, an IP address and a port number of a remote server for the QUIC connection, or a QUIC connection identification used by the remote server; and
transmitting by the session management node to the next plane node, a request to update Packet Forward Control Protocol (PFCP) rules according to the QUIC traffic parameters.

6. (canceled)

7. A wireless communication method comprising:
receiving, by a user plane node from a session management node, a quick UDP Internet connection QUIC; handling instruction; and
transmitting, by the user plane node to the session management node, a QUIC traffic report in response to the QUIC handling instruction.

8. The wireless communication method of claim 7, wherein the QUIC handling instruction comprises at least one of a QUIC traffic detection indication, or a QUIC traffic reporting indication, wherein the QUIC traffic detection indication indicates to the user plane node that a QUIC traffic detection is required, and wherein the QUIC traffic reporting indication instructs the user plane node to report a detection of a QUIC traffic.

9. The wireless communication method of claim 7, wherein the QUIC handling instruction is transmitted through a PFCP session establishment request.

10. The wireless communication method of claim 7, wherein the QUIC traffic report is transmitted through setting a report type of the QUIC traffic report as QUIC traffic detection, and setting the QUIC traffic report to comprise QUIC traffic parameters.

11. The wireless communication method of claim 7, wherein the QUIC traffic report comprises QUIC traffic parameters comprising at least one of: a transport protocol type setting to QUIC, an Internet Protocol: (IP) address and a port number of a user equipment for a QUIC connection, a QUIC connection identification used by the user equipment, a IP address and a port number of a remote server for the QUIC connection, or a QUIC connection identification used by the remote server, and the wireless communication method further comprises:
receiving by the user plane node from the session management node, a request to update Packet Forward Control Protocol (PFCP) rules according to the QUIC traffic parameter.

12. (canceled)

13. The wireless communication method of claim 7, further comprising:
transmitting, by the user plane node to the session management node, a QUIC traffic handling support indication to notify the session management node that the QUIC handling instruction can be transmitted.

14. A wireless communication method comprising:
transmitting, by a session management node to a policy control node, quick UDP internet connection (QUIC); traffic parameters for a QUIC application; and
receiving, by the session management node from the policy control node, Policy and Charging Control: (PCC): rules for a QUIC application, wherein the PCC rules are used to generate Packet Forward Control Protocol; (PFCP); rules to control a user plane node to perform a QUIC traffic detection.

15. The wireless communication method of claim 14, wherein
the QUIC traffic parameters are transmitted through a session management policy association update request message.

16. The wireless communication method of claim 14, wherein the QUIC traffic parameters comprises at least one of: a transport protocol type setting to QUIC, an Internet Protocol: (IP): address and a port number of a user equipment for a QUIC connection, a QUIC connection identification used by the user equipment, a IP address and a port number of a remote server for the QUIC connection, or a QUIC connection identification used by the remote server.

17. The wireless communication method of any of claim 14, wherein the PCC rules are transmitted through a session management policy association update response message.

18. The wireless communication method of claim 14, wherein the PCC rules comprise at least one of: application information, a flow description for identifying an QUIC connection, or Quality of Service (QOS); parameters associated to the QUIC connection, wherein
the application information comprises at least one of an application identification or an application service type;
the flow description comprises at least one of an Internet Protocol (IP) address and a port member of a user equipment for a QUIC connection, a QUIC connection identification used by the user equipment, a IP address and a port number of a remote server for the QUIC connection of a QUIC connection identification used by the remote server, and
the QoS parameter comprises at least one of a QoS Flow Identifier (QFI) an Application and Retention Policy (ARP) a maximum bandwidth of uplink transmission, a maximum bandwidth of a downlink transmission, a guaranteed bandwidth of an uplink transmission, or a guaranteed bandwidth of a downlink transmission.

19. (canceled)

20. The wireless communication method of claim 14, further comprising:
transmitting, by the session management node to the user plane node, the PFCP rules comprising at least one of a Packet Detection Rule; (PDR); a QoS Enforcement Rule: (QER); a Forwarding Action Rule; (FAR): or a Usage Reporting Rule; (URR), and
the PFCP rules least one of a QUIC traffic detection indication, an IP address and a port number of a user equipment for a QUIC connection, a QUIC connection identification used by the user equipment, a IP address and a port number of a remote server for the QUIC connection, or a QUIC connection identification used by the remote server.

21-35. (canceled)

36. A wireless communication node, comprising:
a communication unit; and
a processor, configured to perform the wireless communication method of claim 1.

37. (canceled)

38. A wireless communication node, comprising:
a communication unit; and
a processor configured to perform the wireless communication method of claim 7.

39. (canceled)

40. A wireless communication node, comprising:
a communication unit; and
a processor configured to perform the wireless communication method of claim 14.

41-46. (canceled)
